(19) United States
(12) Patent Application Publication
(10) Pub. No.: US 2004/0177066 A1
(43) Pub. Date: Sep. 9, 2004

(54) Network

(75) Inventor: Toshiaki Igarashi, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/784,973

(22) Filed: Feb. 25, 2004

(30) Foreign Application Priority Data
Mar. 7, 2003 (JP) 2003-060870

(51) Int. Cl. G06F 7/00

(52) U.S. Cl. 707/3

(57) ABSTRACT

A network device managing apparatus is designed so that when a list of network devices or a list showing states of the network devices is displayed in accordance with a request from a data processing apparatus, the network device to be emphasis-displayed is changed every user or every data processing apparatus.

### BACKGROUND OF THE INVENTION

1. Field of the Invention

The invention relates to a network device managing apparatus which communicates with a network device or a plurality of data processing apparatuses via a network in accordance with a predetermined protocol and manages the network device.

2. Related Background Art

Hitherto, various network devices and computers as component elements of a network device managing system are mutually connected by what is called a Local Area Network (LAN).

In such a network system, a special user called an “administrator” exists and always executes expansion or deletion of apparatuses such as network devices and the like, updating of software, detection of a problem, or the like.

In recent years, the apparatuses which are managed by the network device managing system have become increasingly complicated and a burden on the administrator has also become very heavy in association with it. Therefore, there is a pressing demand that the burden on the administrator is reduced.

In order to make the management of the network devices easy and reduce the burden on the administrator in the network system, according to a network device managing apparatus, when a network device which has newly been expanded in the system is found out, not only the network device is not simply additionally displayed on a device list (a list to display the network devices) but emphasis-displayed.

That is, the network device managing apparatus holds information of the current network device list into a storing medium (hard disk, RAM, etc.) before the device list is updated to the latest information.

After that, the device list is updated to the latest information, thereby forming the latest network device list information.

Finally, those two pieces of the network device list information are compared and the network device which exists only in the latest network device list information is emphasis-displayed.

In such a network device managing apparatus according to the prior art, since visibility for the administrator is enhanced compared to that in the case where the network device which has newly been expanded in the system is simply added to the device list, there is a case where the burden on the administrator is reduced.

In the above prior art, however., the network device to be emphasis-displayed is determined when the network device managing apparatus updates the device list to the latest information. Therefore, in the case of a server-client form in which a plurality of users obtain the device list information from the network device managing apparatus serving as a server and display it on Web browsers or the like on client PCs, the emphasis-display on the device lists for all users is always identical.

For example, in the case where a network device A is connected, the user A (client PC of the user A) obtains the device list and, thereafter, a network device B is connected, while the network device which is new to the user A is only the network device B, the network devices which are new to the user B who obtains the device list for the first time are the network devices A and B. However, in the conventional network device managing apparatus, the same device list is provided to both user A and user B. That is, a device list on which the network devices A and B are emphasis-displayed is provided to both user A and user B or a device list on which only the network device B is emphasis-displayed is provided to both user A and user B.

In other words, according to the above prior art, there is such a problem that the emphasis-display of “the network device which has newly been expanded” which can be different to each user cannot be controlled every user.

### SUMMARY OF THE INVENTION

The invention is made to solve the above problems and it is an object of the invention that when a list of network devices or a list showing states of the network devices is displayed, which one of the network devices is emphasis-displayed can be changed every user or every data processing apparatus.

### BRIEF DESCRIPTION OF THE DRAWINGS

FIG. 1 is a diagram for explaining a construction of a network device managing apparatus to which a server apparatus and an information processing apparatus showing the first embodiment of the invention can be applied;

FIG. 2 is a block diagram for explaining a construction of PCs shown in FIG. 1;

FIG. 3 is a diagram showing an example of a network device table which is managed in an RAM shown in FIG. 2;

FIG. 4 is a flowchart showing an example of a first data processing procedure in the network device managing apparatus according to the invention;

FIGS. 5A and 5B are diagrams showing examples of a network device updating state display screen in the network device managing apparatus according to the invention;

FIG. 6 is a flowchart showing an example of a second data processing procedure in the network device managing apparatus according to the invention;

FIG. 7 is a diagram for explaining a memory map of a network device managing program which can be applied to the network device managing apparatus according to the invention; and

FIG. 8 is a diagram for explaining a memory map in a storing medium for storing various data processing programs which can be read out by the network device managing apparatus according to the invention.

### DETAILED DESCRIPTION OF THE PREFERRED EMBODIMENT

First embodiment

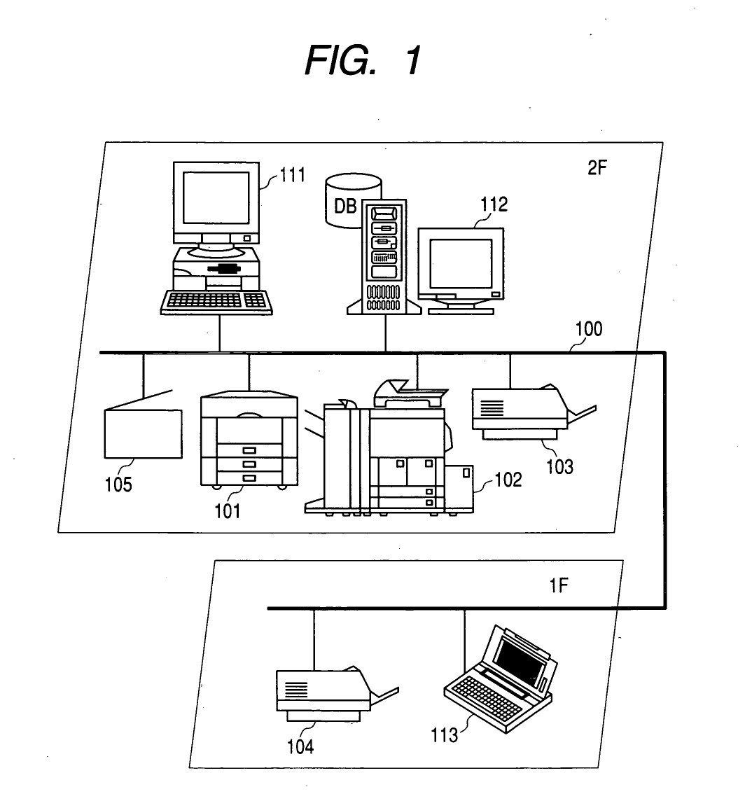

FIG. 1 is a diagram for explaining a construction of a network device managing apparatus to which a server apparatus and an information processing apparatus showing the first embodiment of the invention can be applied. For example, FIG. 1 corresponds to an example of a system in which network devices on a floor in which layout constructions are physically different can communicate.

In FIG. 1, reference numeral 101 denotes a color printer and 102 indicates an MFP (Multi Function Peripheral). They are constructed so that they can be also used as network printers.

Reference numerals 103 and 104 denote monochromatic printers and 105 indicates a scanner connected to a network. They are nothing but examples of network devices and, naturally, the present invention can be applied to network devices other than those shown in the examples. That is, any network devices become management targets of the embodiment so long as they can be connected to the network.

A program for managing the network devices (hereinafter, simply abbreviated to a managing program) according to the embodiment can be executed on those network devices or, naturally, they can be also executed on external PC 111 or 112 or a PC 113.

In the case of executing the managing program on the network devices, it can be executed on each network device or, as an extreme example, it is also possible that it is executed on one arbitrary network device and not only its own device but also the other network devices are managed. It is a main function of the managing program that the network devices in the network device managing apparatus are searched and states of the searched network devices are managed. There is a case where the component elements 101 to 105 are called network devices.

In the example shown in the diagram, the PCs 111 and 112 are constructed by desktop PCs and the PC 113 is constructed by a notebook PC.

The PCs 111, 112, and 113 are the PCs which can execute the managing program according to the embodiment and search for the network device in the network device managing system or manage a state of the searched network device as will be explained hereinlater. All of those devices are connected to the network by a LAN 100.

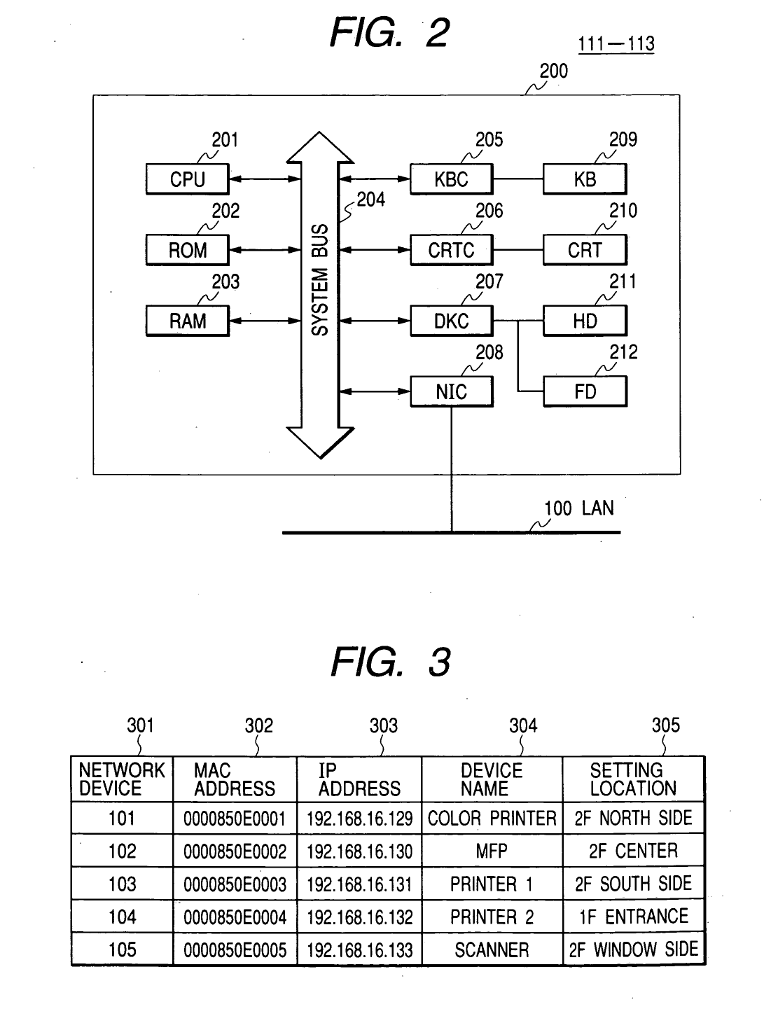

FIG. 2 is a block diagram for explaining a construction of the PCs 111, 112, and 113 shown in FIG. 1. They have an internal construction of a general personal computer.

In FIG. 2, reference numeral 200 denotes a PC in which the managing program operates and this PC is equivalent to the PC 111 or 112 or the PC 113 in FIG.

The PC 200 has a CPU 201 for executing the managing program which has been stored in a ROM 202 or a hard disk (HD) 211 or which is supplied from a flexible disk drive (FD) 212. The PC 200 integratedly controls each network device connected to a system bus 204.

Reference numeral 203 denotes a RAM which functions as a main memory, a work area, or the like of the CPU 201; 205 a keyboard controller (KBC) for controlling an instruction input from a keyboard (KB) 209, a pointing device (not shown), or the like; and 206 a CRT controller (CRTC) for controlling a display of a CRT display (CRT) 210.

Reference numeral 207 denotes a disk controller (DKC) for controlling an access to a storing apparatus such as CD-ROM (not shown), hard disk (HD) 211, flexible disk drive (FD) 212, or the like. A boot program, an operating system, various applications, an edit file, a user file, the managing program, and the like have been stored in the hard disk (HD) 211, the flexible disk drive (FD) 212, or the like.

Reference numeral 208 denotes a network interface card (NIC) as a communicating apparatus for bidirectionally transmitting and receiving data to/from the network printers, other network devices, or other PCs via the LAN 100.

A construction and the operation of the network device managing system will now be described.

FIG. 3 is a diagram showing an example of a network device table which is managed in the RAM 203 shown in FIG. 2. FIG. 3 shows an example in the case where data which is concerned with the network devices and which has been stored in the desktop PC 111, the PC 112 as a server, the notebook PC 113, or the color printer 101 to the scanner 105 is expressed in a table format.

FIG. 3 shows a state where an MAC address 302, an IP address 303, a device name 304, and a setting location 305 have been registered for each of the network devices 101 to 105 shown in a network device 301, respectively.

Information shown in FIG. 3 is merely shown as an example. Therefore, naturally, further, other additional information such as product names of the network devices and the like can be also included.

An example of a management protocol of the network devices which can be used in the embodiment will now be described.

Several organizations for standardization have standardized the management protocol so far. For example, ISO (International Organization for Standardization) provides a general reference frame work called an OSI (Open Systems Interconnection) model. The OSI model of the network management protocol is called CMIP (Common Management Information Protocol). The CMIP is a common network management protocol in Europe.

In the U.S.A., a modification of the CMIP called SNMP (Simple Network Management Protocol) exists as a network management protocol of high commonness.

The SNMP is disclosed in detail in “The Simple Book: An Introduction to Management of TCP/IP-based Internets”, Marshall T. Rose, Prentice-Hall Inc. 1991.

According to the above SNMP network managing technique, at least one network managing station, a management target node, an agent provided for the management target node, and a network management protocol which is used for exchanging management information by the network managing station or agent are included in the network managing system.

The user can obtain data on the network and change the data by communicating with agent software on the management target node by using the network device managing software on the network managing station. The “agent” here denotes software which runs as a background process regarding each target apparatus.

When the user requests management data from the apparatus on the network, the managing software inserts object identification information into a management packet or frame and sends it to a target agent. Thus, the agent interprets the object identification information, extracts data corresponding to the object identification information, inserts the extracted data into the packet, and returns it to the user. There is also a case where a corresponding process is called in order to extract the data.

The agent holds data regarding its own state in a format of a database (called MIB (Management Information Base)). The MIB has a data structure of a tree structure and all nodes have unconditionally been numbered. The structure of the MIB is called SMI (Structure of Management Information) and has been specified by RFC1155 “Structure and Identification of Management Information for TCP/IP-based Internets”.

Further, the agent is installed onto a network board for connecting the printer to the network or installed in the printer. Thus, the printer can be set to a target of management by the network device managing software.

The user can obtain information of the printer as a control target and change the state by using the network device managing software. More specifically speaking, for example, the user can obtain a character string displayed on a liquid crystal display of the printer or change a paper feed cassette of a default.

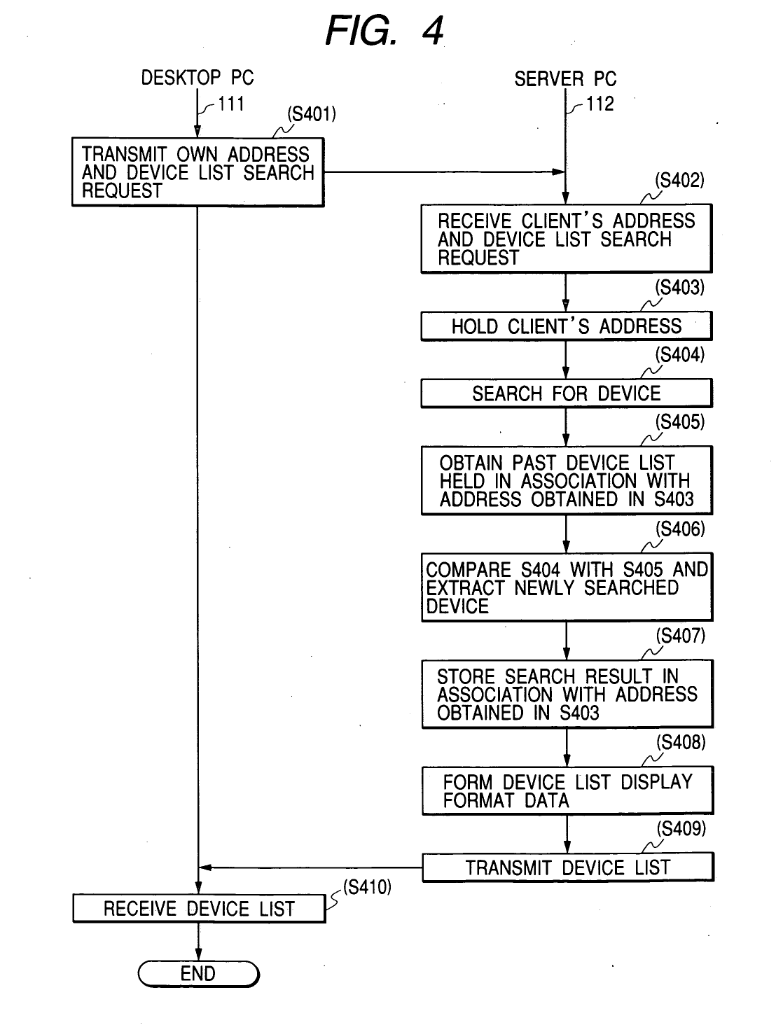

FIG. 4 is a flowchart showing an example of a first data processing procedure in the network device managing apparatus according to the invention and corresponds to the data processing procedure of the network device managing program which operates on the PC 200 shown in FIG. 2. S401 and S410 denote processing steps in the desktop PC 111. S402 to S409 denote processing steps in the server PC 112.

In the embodiment, the PC 200 is the PC 111 or 112 or the PC 113 in FIG. 1. For simplicity of explanation, the server 112 is presumed as a PC 200 here. Further, discrimination and execution of a series of processes are made by the CPU 201 in the PC 200 in a hardware manner.

The PC 111 or 112 or the PC 113 can be mentioned as an example of the client PC which communicates with the PC 200. For simplicity of explanation, the desktop PC 111 is presumed as a client PC.

While the network device managing program is executed on the server 112, when the desktop PC 111 executes step S401, the present flowchart is started.

In step S401, the desktop PC 111 transmits a device list search request to the server 112. At this time, the desktop PC 111 also transmits it's own address together with it.

As an address which is transmitted in this step, any address such as IP address, IPX address, DDP address, MAC address, or the like can be used so long as the network printers can be unconditionally identified.

In step S402, when the server 112 receives the request and address transmitted in step S401, the address of the desktop PC 111 received in step S402 is held into the work area of the RAM 203 shown in FIG. 2 in step S403.

In next step S404, the network device connected to the network is newly searched.

A method of searching for the network device connected to the network is not specified. For example, there is a method of searching for the network device by global-transmitting a “GetRequest” of the SNMP.

It is assumed that a list of the network devices searched here is temporarily held in the work area of the RAM 203 shown in FIG. 2. At this time, the list of the devices is formed.

In step S405, a list of the devices searched and held by a request from the desktop PC 111 in the past is read out from a cache (for example, held in the RAM 203).

If each procedure shown in FIG. 4 has been executed at least once, the list of the devices held in step S407, which will be explained hereinafter, which was executed in the past can be easily read out by using the address held in step S403 as a key.

It is assumed that the read-out device list is temporarily held in the work area of the RAM 203 in a manner similar to step S403.

Subsequently, in step S406, the list of the devices searched in step S404 and the device list read out in step S405 are compared and the device searched newly by the present device search (that is, the device which exists in the list of the devices found by the search in step S404 but does not exist in the device list read out in step S405) is extracted.

It is assumed that an extraction result is held in the work area of the RAM 203 and can be referred to as necessary.

If the list of the devices held in the cache does not exist in step S405, all of the devices searched in step S404 are extracted as newly searched devices.

Subsequently, in step S407, the address of the desktop PC 111 held in step S403 and the list of the devices searched in step S404 are held in the RAM 203 in association with each other.

As mentioned in step S405, this step is a processing step for holding information which is necessary to execute step S405 when the present flowchart is executed by the network device managing apparatus in the future.

In step S408, display format data of the device list for the desktop PC 111 for emphasis-displaying the devices extracted in step S406 in the list of the devices searched in step S404 is formed.

In the embodiment, as processing methods which can emphasis-display the extracted devices, there are (1) a method of displaying them in bold characters, (2) a method of adding check marks, (3) a method of displaying them in a lump in an upper portion of a display screen of the desktop PC, and the like. However, the invention is not limited to those methods.

Subsequently, the data formed in step S408 is transmitted to the desktop PC 111 in step S409.

Finally, in step S410, the desktop PC 111 receives the data in step S409, displays it onto the CRT display (CRT) 210 via the CRT controller (CRTC) 206, and finishes the present processing routine.

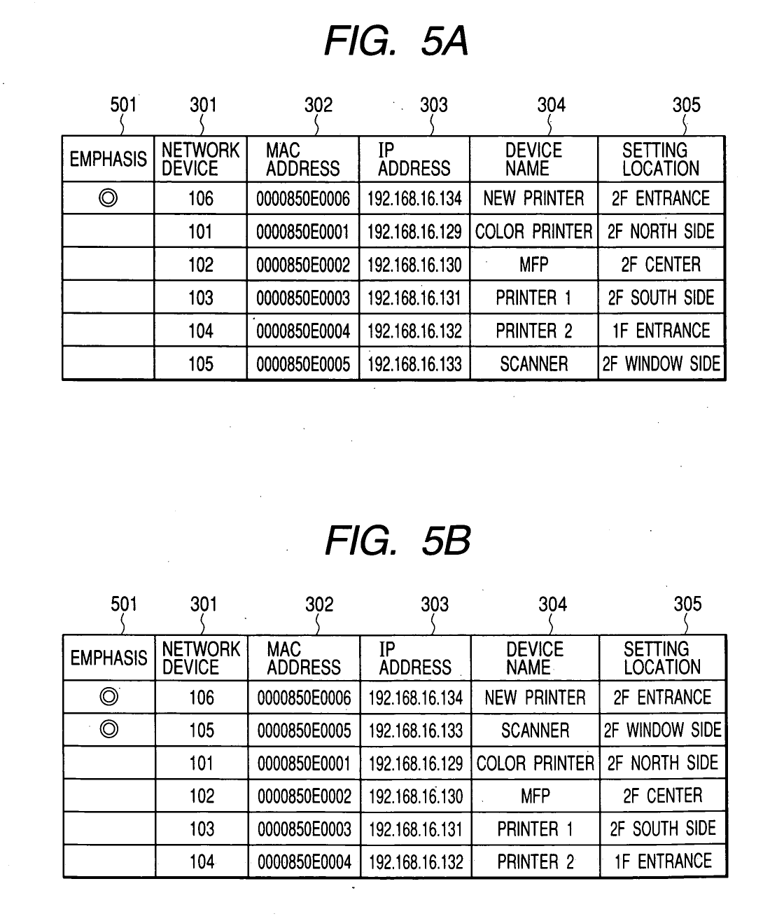

Examples in which different display results are displayed onto display screens of a plurality of client PCs are shown in FIGS. 5A and 5B.

FIGS. 5A and 5B are diagrams showing examples of a network device updating state display screen in the network device managing apparatus according to the invention. For simplicity of explanation, it is assumed that FIG. 5A corresponds to the display screen of the desktop PC 111 and FIG. 5B corresponds to the display screen of the notebook PC 113. The same component elements as those in FIG. 3 are designated by the same reference numerals.

In FIG. 5A, reference numeral 501 denotes an emphasis display column accompanied with the execution of step S410 shown in FIG. 4.

In the embodiment, examples realized by the foregoing emphasis displaying methods (2) and (3) among the examples of the emphasis displaying methods described in step S408 shown in FIG. 4 is shown.

That is, with respect to a network device 106 which has newly been searched, a mark “⊚” is added to the emphasis display column 501. By displaying the network device 106 to the highest position, this network device is emphasis-displayed (as another method, a blink-displaying method or a different-color displaying method can be also arbitrarily used).

In FIG. 5B, as a result different from FIG. 5A, the network device updating state display screen is shown.

That is, network devices 105 and 106 are emphasis-displayed as network devices which were newly searched. It means that when the processing routine shown in the flowchart of FIG. 4 is executed by a request from the notebook PC 113, the network devices 105 and 106 were newly searched for the notebook PC 113 unlike the case (FIG. 5A) of the desktop PC 111.

The network device managing program according to the invention described above can be also executed by the PC 200 in accordance with a program which is installed from the outside.

In such a case, the invention is also applied to the case where such a program is supplied to the PC 200 from a storing medium such as CD-ROM, flash memory, flexible disk, or the like or an information group including the program is loaded into the PC 200 from an external storing medium via a network such as E-mail, personal computer communication, or the like and supplied to the PC 200.

Second embodiment

The case where the network device managing program searches for the network device has been described in the first embodiment. It is also possible to use such a construction that the network device managing program detects a change in states of one or a plurality of network devices which have already been searched. Such an embodiment will be described hereinbelow.

Since a construction of the system (refer to FIG. 1), a construction of resources of the hardware (refer to FIG. 2), and further, data regarding the network devices (refer to FIG. 3) are similar to those in the first embodiment, their description is omitted here.

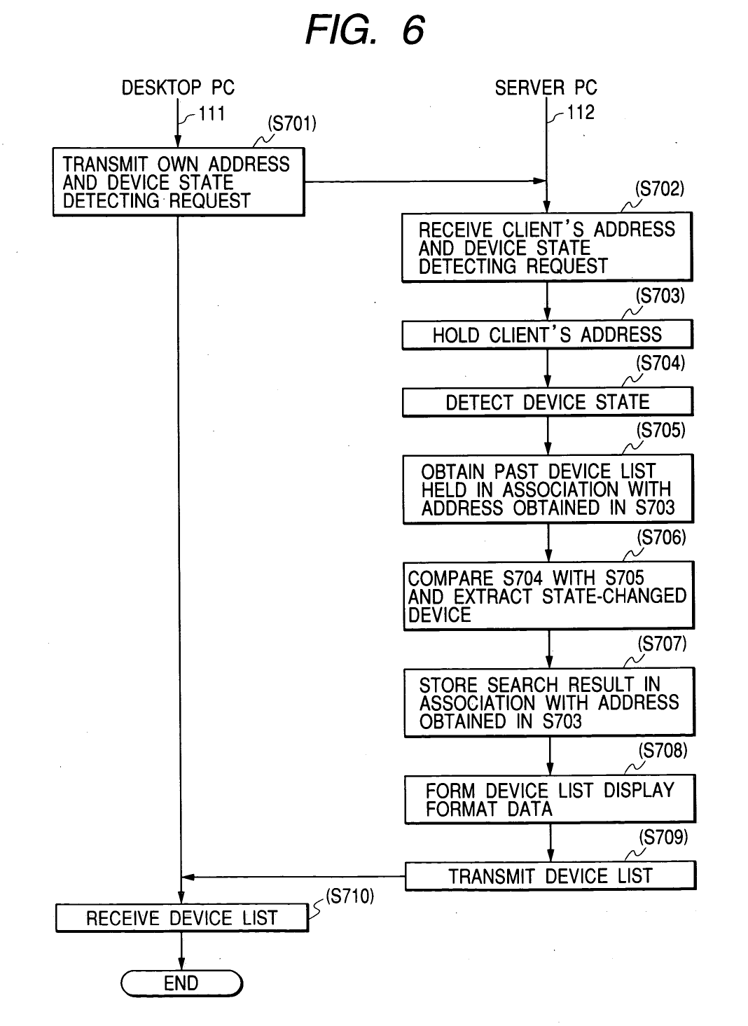

FIG. 6 is a flowchart showing an example of a second data processing procedure in the network device managing apparatus according to the invention and corresponds to the data processing procedure of the network device managing program which operates on the PC 200 shown in FIG. 2. S701 and S710 denote processing steps in the desktop PC 111. S702 to S709 denote processing steps in the server PC 112.

Discrimination and execution of a series of processes are made by the CPU 201 in the PC 200 in a hardware manner.

The PC 111 or 112 or the PC 113 can be mentioned as an example of the client PC which communicates with the PC 200. For simplicity of explanation, the desktop PC 111 is presumed as a client PC here.

While the network device managing program is executed on the server 112, when the desktop PC 111 executes step S701, the present flowchart is started.

In step S701, the desktop PC 111 transmits a device state detecting request to the server 112.

The “device state detection” here denotes that the PC inquires of each network device included in the device list which has already been obtained in the first embodiment or the like about its state (whether the printer is in a printable state or not, whether an error has occurred or not, or the like).

In this step, the desktop PC 111 also transmits its own address together in a manner similar to that in step S401 in FIG. 4.

In step S702, when the server 112 receives the request and address transmitted in step S701, step S703 is executed. That is, the same process as that of step S403 in FIG. 4 is executed in step S703.

Subsequently, in step S704, the device state detection is executed for the network device which has already been searched by the request from the desktop PC 111. A method of detecting the states of network devices connected to the network is not specified.

For example, there is a method of detecting the state of the network device by transmitting the “GetRequest” of the SNMP.

It is assumed that the state of the network device detected here is temporarily held in the work area of the RAM 203 shown in FIG. 2.

In next step S705, the same process as that in step S405 is executed. In step S706, a list of the devices whose states have been detected in step S704 and a device list read out in step S705 are compared and the device whose state has newly been changed in the present device state detection is extracted.

An extraction result is held in the work area of the RAM 203 and can be referred to as necessary.

In steps S707 to S710, the same processes as those in steps S407 to S410 shown in FIG. 4 are executed.

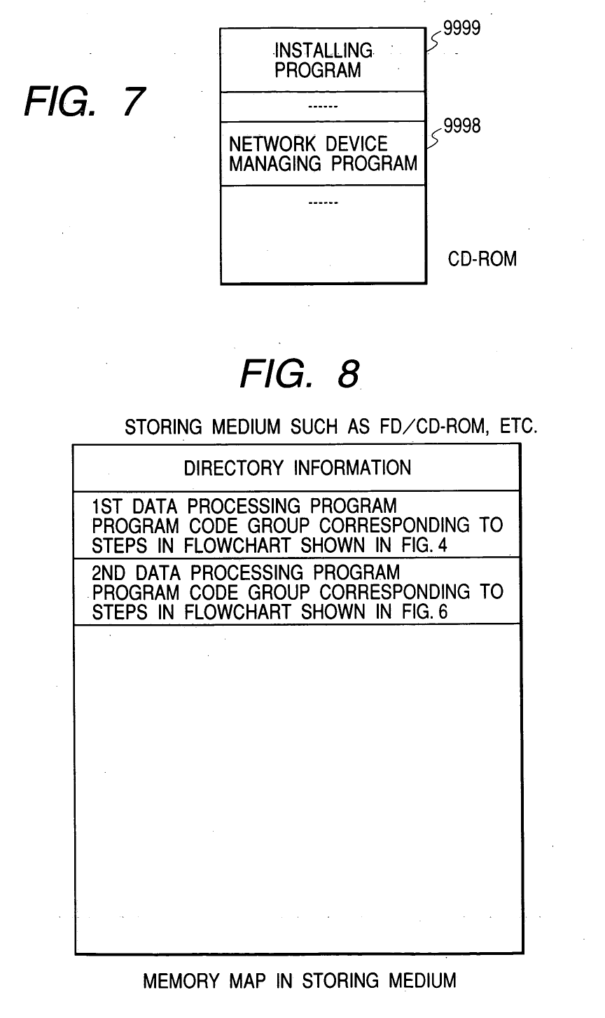

FIG. 7 is a diagram for explaining a memory map of a network device managing program which can be applied to the network device managing apparatus according to the invention and corresponds to, for example, an example of the CD-ROM as a storing medium.

In FIG. 7, reference numeral 9999 denotes an area in which an installing program has been stored and 9998 indicates an area in which the network device managing program has been stored.

When the network device managing program according to the procedure shown in FIG. 4 or 6 is installed into the PC 200, first, the installing program stored in the area 9999 in which the installing program has been stored is loaded into the system and executed by the CPU 201. Subsequently, the installing program which is executed by the CPU 201 reads out the network device managing program from the area 9998 in which the network device managing program has been stored and stores it into the hard disk 211.

The invention can be applied to a system or a hybrid apparatus constructed by a plurality of apparatuses (for example, a host computer, an interface apparatus, a reader, etc.) or can be also applied to an apparatus comprising one equipment.

Naturally, the invention can be also applied to the case where the program is distributed to a requestor via a communication line such as personal computer communication or the like from a storing medium in which program codes of software to realize the functions of the embodiments mentioned above have been recorded.

Further, in the first or second embodiment, it is also possible to construct the apparatus in such a manner that instruction data to display the data in a state where a device icon on the data processing apparatus source side has been updated is included in the display format data formed in step S408 in FIG. 4 or step S708 in FIG. 6 and such a device icon can be displayed in a form which is visually different from that of the icons of the other network devices (for example, the icon is displayed so as to flicker, the icon is displayed in a different color, a specific symbol is added to the icon, or the like) on the data processing apparatus side.

A construction of a data processing program which can be read out by the network device managing apparatus according to the invention will be described hereinbelow with reference to a memory map shown in FIG. 8.

FIG. 8 is a diagram for explaining the memory map in the storing medium for storing various data processing programs which can be read out by the network device managing apparatus according to the invention.

Although not shown in particular, there is a case where information to manage the program group which is stored in the storing medium, for example, version information, implementors, and the like are stored and information depending on the OS or the like on the program reading side, for example, icons to identify and display the programs, and the like are also stored.

Further, data depending on various programs is also managed in the directory. There is also a case where a program for installing the various programs into a computer and, if the installing program has been compressed, a program for decompressing it and the like are also stored.

The functions shown in FIGS. 4 and 6 in the embodiments can be executed by a host computer in accordance with a program which is installed from the outside. In such a case, the invention is also applied to the case where an information group including the program is supplied to an output apparatus by the storing medium such as CD-ROM, flash memory, FD, or the like or from an external storing medium via the network.

Naturally, the objects of the invention is accomplished by a method whereby a storing medium in which the program codes of the software to realize the functions of the embodiments mentioned above have been recorded is supplied to a system or an apparatus and a computer (or a CPU or an MPU) of the system or the apparatus reads out and executes the program codes stored in the storing medium.

In this case, the program codes themselves read out from the storing medium realize the novel functions of the invention and the storing medium in which the program codes have been stored construct the invention.

As a storing medium to supply the program codes, for example, for example, a flexible disk, a hard disk, an optical disk, a magnetooptic disk, a CD-ROM, a CD-R, a magnetic tape, a nonvolatile memory card, a ROM, an EEPROM, or the like can be used.

Naturally, the invention incorporates not only the case where the computer executes the read-out program codes, so that the functions of the embodiments mentioned above are realized but also the case where the OS (Operating System) or the like which is operating on the computer executes a part or all of actual processes on the basis of instructions of the program codes and the functions of the embodiments mentioned above are realized by those processes.

Further, naturally, the invention incorporates the case where the program codes read out from the storing medium are written into a memory provided for a function expanding board inserted in a computer or a function expanding unit connected to a computer and, thereafter, a CPU or the like provided for the function expanding board or the function expanding unit executes a part or all of actual processes on the basis of instructions of the program codes and the functions of the embodiments mentioned above are realized by those processes.

The invention is not limited to the foregoing embodiments but various modifications (including organic combinations of the embodiments) are possible on the basis of the spirit of the invention and they are not excluded from the scope of the invention.

According to the above construction, the network device list information which is obtained from the network device managing apparatus and includes the emphasis-display is switched every user, so that the finer network device list information can be provided to the user.

There is also such an effect that since the user can promptly find out the state-changed network device, even if some fault occurred in this network device, it is possible to rapidly cope with such a situation.

What is claimed is:

1. A network device managing apparatus comprising:
receiving means for receiving a search request of network devices and identification information from a data processing apparatus;
list forming means for forming a list of the network devices;
holding means for holding the identification information received by said receiving means and the list formed by said list forming means in association with each other;
extracting means for, if the search request and the identification information are received by said receiving means, comparing the list held by said holding means in association with said identification information with the list formed by said list forming means after said search request was received by said receiving means and extracting network devices which have newly been found;
data forming means for forming data which emphasizes the network devices extracted by said extracting means and which is used to display the list of the network devices; and
data transmitting means for transmitting the data formed by said data forming means to said data processing apparatus.

2. A network device managing apparatus which can communicate with network devices and a data processing apparatus, comprising:
receiving means for receiving a state request of the network devices and identification information from said data processing apparatus;
list forming means for obtaining a state of each of said network devices and forming a list showing the states of the network devices;
holding means for holding the identification information received by said receiving means and the list formed by said list forming means in association with each other;
extracting means for, if the state request and the identification information are received by said receiving means, comparing the list held by said holding means in association with said identification information with the list formed by said list forming means after said state request was received by said receiving means and extracting network devices whose states have been changed;
data forming means for forming data which emphasizes the network devices extracted by said extracting means and which is used to display the list showing the states of the network devices; and
data transmitting means for transmitting the data formed by said data forming means to said data processing apparatus.

3. An apparatus according to claim 2, wherein said list indicates at least one of information regarding whether printing is possible or not and an error state.

4. An apparatus according to claim 1, wherein the data formed by said data forming means includes an emphasis mark to emphasize.

5. An apparatus according to claim 1, wherein the data formed by said data forming means includes instruction data for allowing a device icon of the data processing apparatus to be displayed in an updated state.

6. A method comprising:
a first receiving step of receiving a request and identification information from a data processing apparatus;
a first list forming step of forming a list of network devices in accordance with the request received in said first receiving step;
a holding step of holding the identification information received in said first receiving step and the list formed in said first list forming step in association with each other;
a second receiving step of receiving a request and identification information from the data processing apparatus;
a second list forming step of forming a list of network devices in accordance with the request received in said second receiving step;
a comparing step of comparing the list held in association with the same identification information as the identification information received in said second receiving step with the list formed in said second list forming step in order to extract network devices which have newly been found;
a data forming step of forming data which emphasizes the newly found network devices and which is used to display the list of the network devices; and
a data transmitting step of transmitting the data formed in said data forming step to said data processing apparatus.

7. A method according to claim 6, wherein the data formed in said data forming step includes an emphasis mark to emphasize.

8. A method according to claim 6, wherein the data formed in said data forming step includes instruction data for allowing a device icon of the data processing apparatus to be displayed in an updated state.

9. A method comprising:
a first receiving step of receiving a request and identification information from a data processing apparatus;
a first list forming step of forming a list showing states of network devices in accordance with the request received in said first receiving step;
a holding step of holding the identification information received in said first receiving step and the list formed in said first list forming step in association with each other;
a second receiving step of receiving a request and identification information from the data processing apparatus;
a second list forming step of forming a list showing states of network devices in accordance with the request received in said second receiving step;
a comparing step of comparing the list held in association with the same identification information as the identification information received in said second receiving step with the list formed in said second list forming step in order to extract network devices whose states have been changed;
a data forming step of forming data which emphasizes the state-changed network devices and which is used to display the list showing the states of the network devices; and
a data transmitting step of transmitting the data formed in said data forming step to said data processing apparatus.

10. A method according to claim 9, wherein said list indicates at least one of information regarding whether printing is possible or not and an error state.

11. A method according to claim 9, wherein the data formed in said data forming step includes an emphasis mark to emphasize.

12. A program for controlling a computer so as to execute:
a first receiving step of receiving a request and identification information from a data processing apparatus;
a first list forming step of forming a list of network devices in accordance with the request received in said first receiving step;
a holding step of holding the identification information received in said first receiving step and the list formed in said first list forming step in association with each other;
a second receiving step of receiving a request and identification information from the data processing apparatus;
a second list forming step of forming a list of network devices in accordance with the request received in said second receiving step;
a comparing step of comparing the list held in association with the same identification information as the identification information received in said second receiving step with the list formed in said second list forming step in order to extract network devices which have newly been found;
a data forming step of forming data which emphasizes the newly found network devices and which is used to display the list of the network devices; and
a data transmitting step of transmitting the data formed in said data forming step to said data processing apparatus.

13. A program for controlling a computer so as to execute:
a first receiving step of receiving a request and identification information from a data processing apparatus;
a first list forming step of forming a list showing states of network devices in accordance with the request received in said first receiving step;
a holding step of holding the identification information received in said first receiving step and the list formed in said first list forming step in association with each other;
a second receiving step of receiving a request and identification information from the data processing apparatus;
a second list forming step of forming a list showing states of network devices in accordance with the request received in said second receiving step;
a comparing step of comparing the list held in association with the same identification information as the identification information received in said second receiving step with the list formed in said second list forming step in order to extract network devices whose states have been changed;
a data forming step of forming data which emphasizes the state-changed network devices and which is used to display the list showing the states of the network devices; and
a data transmitting step of transmitting the data formed in said data forming step to said data processing apparatus.
